(19) United States
(12) Patent Application Publication
(10) Pub. No.: US 2010/0287770 A1
(43) Pub. Date: Nov. 18, 2010

(54) MANUFACTURING AN ELECTRODE CARRIER FOR AN IMPLANTABLE MEDICAL DEVICE

(75) Inventors: Fysh Dadd, Lane Cove (AU); Derek Ian Darley, Cromer Heights (AU); Dusan Milojevic, Wheelers Hill (AU); Peter Gibson, South Coogee (AU); John L. Parker, Roseville (AU); Claudiu Treaba, Englewood, CO (US); Miroslaw Mackiewicz, (US)

Correspondence Address: KILPATRICK STOCKTON LLP, 1100 Peachtree Street, Suite 2800, ATLANTA, GA, 30309, US

(73) Assignee: COCHLEAR LIMITED, Lane Cove, NSW (AU)

(21) Appl. No.: 12/466,254

(22) Filed: May 14, 2009

(51) Int. Cl. H01R 43/00

(52) U.S. Cl. 29/877

(57) ABSTRACT

According to one aspect of the present invention, there is provided a method for manufacturing an electrode carrier comprising one or more electrode contacts of an implantable medical device, comprising: coupling at least one electrode to a base plate, securing the base plate in a mold, injecting the mold with injection material at least partially around the at least one electrode coupled to the base plate, curing the injected material, and decoupling the at least one electrode from the base plate such that the cured injection material is separated from the base plate.

### BACKGROUND

1. Field of the Invention

The present invention relates generally to implantable medical devices, and more particularly, to manufacturing an electrode carrier for an implantable medical device.

2. Related Art

Implantable medical devices have become more commonplace as their therapeutic benefits become more widely accepted and the impact and risk of their use have been managed. Such implantable medical devices include a category of devices which stimulate tissue in the recipient's body including, for example, epithelial tissue, connective tissue, muscle tissue and nerve tissue. These stimulating implantable medical devices generally comprise a stimulator that generates an electrical, optical, or other stimulation signals. Some stimulating implantable medical devices provide the signals to the target tissue by implanting a carrier member having one or more electrode contacts. In addition to providing stimulation signals via electrode contacts on the carrier member, the electrode contacts may be used to sense or receive signals from the implantee's adjacent tissue in other implantable medical devices.

Hearing loss, which may be due to many different causes, is generally of two types, conductive and sensorineural. In some cases, a person may have hearing loss of both types. Conductive hearing loss occurs when the normal mechanical pathways for sound to reach the hair cells in the cochlea are impeded, for example, by damage to the ossicles. Conductive hearing loss is often addressed with conventional hearing aids which amplify sound so that acoustic information can reach the cochlea.

In many people who are profoundly deaf, however, the reason for their deafness is sensorineural hearing loss. This type of hearing loss is due to the absence or destruction of the hair cells in the cochlea which transduce acoustic signals into nerve impulses. Those suffering from sensorineural hearing loss are thus unable to derive suitable benefit from conventional hearing aids due to the damage to or absence of the mechanism for naturally generating nerve impulses from sound.

Prosthetic hearing implants such as auditory brain stimulators and cochlear implants (also commonly referred to as cochlear implant devices, cochlear prostheses, and the like; simply “cochlear implant” herein) are generally used to treat sensorineural hearing loss. Cochlear implants bypass the hair cells in the cochlea, directly delivering electrical stimulation to the auditory nerve fibers via an implanted electrode assembly. This enables the brain to perceive a hearing sensation resembling the natural hearing sensation normally delivered to the auditory nerve.

The manufacture of an electrode carrier requires precision to perform the intended stimulation. Variations in the manufactured device may reduce the effectiveness of the applied stimulation resulting in quality control/assurance problems, customer service issues, and so on.

### SUMMARY

According to one aspect of the present invention, there is provided a method for manufacturing an electrode carrier comprising one or more electrode contacts of an implantable medical device, comprising: coupling at least one electrode to a base plate, securing the base plate in a mold, injecting the mold with injection material at least partially around the at least one electrode coupled to the base plate, curing the injected material, and decoupling the at least one electrode from the base plate such that the cured injection material is separated from the base plate.

According to another aspect of the present invention, there is provided a system for manufacturing an implantable assembly of a medical device, the assembly comprising a carrier with one or more electrode contacts disposed there in, comprising: means for coupling the one or more electrode contacts to a base plate, means for securing the base plate in a mold, means for injecting the mold with injection material at least partially around the one or more electrode contacts, means for curing the injected material, and means for decoupling the one or more electrode contacts from the base plate such that the cured injection material is separated from the base plate.

### BRIEF DESCRIPTION OF THE DRAWINGS

Embodiments of the present invention are described below with reference to the attached drawings, in which:

FIG. 1 is a perspective view of an exemplary implantable medical device, commonly referred to as a cochlear implant, in which embodiments of the present invention may be advantageously implemented;

FIG. 2A is a perspective, partially cut-away view of a cochlea exposing the canals and nerve fibers of the cochlea and showing an electrode carrier, according to embodiments of the present invention;

FIG. 2B is a cross-sectional view of one turn of the canals of a human cochlea and an electrode carrier, according to embodiments of the present invention positioned therein;

FIG. 3 is a flowchart of the operations performed to manufacture an electrode carrier of an implantable medical device, according to embodiments of the present invention;

FIG. 4A is a simplified perspective view of an electrode for an electrode carrier prior to being deformed, according to embodiments of the present invention;

FIG. 4B is a simplified perspective view of the electrode of FIG. 4A after undergoing a partial deformation, according to embodiments of the present invention;

FIG. 4C is a simplified perspective view of the electrode of FIG. 4A after being deformed, according to embodiments of the present invention;

FIG. 4D is a simplified perspective view of an electrode formed from a plate, according to embodiments of the present invention;

FIG. 5A is a perspective view of a base plate used to manufacture an electrode carrier, according to embodiments of the present invention;

FIG. 5B is a perspective view of the base plate of FIG. 5A with multiple electrode contacts attached thereto during manufacture of an electrode carrier, according to embodiments of the present invention;

FIG. 5C is a perspective view of an injection mold and a rod for forming a lumen used to manufacture an electrode carrier, according to embodiments of the present invention;

FIG. 5D is a more detailed view of a base plate in an injection mold used to manufacture an electrode carrier, according to other embodiments of the present invention;

FIG. 5E is a perspective view of the injection mold of FIG. 5C used to manufacture an electrode carrier, according to embodiments of the present invention prior to the injection of material into the mold;

FIG. 5F is a perspective view of the injection mold of FIG. 5C used to manufacture an electrode carrier, according to embodiments of the present invention after the injection of material into the mold;

FIG. 5G is a perspective view of an electrode carrier manufactured, according to embodiments of the present invention;

FIG. 6 is a simplified cross-section of an electrode carrier manufactured, according to embodiments of the present invention;

FIG. 7 is a perspective view of an electrode carrier manufactured according to embodiments of the present invention;

FIG. 8A is a perspective view of a mold comprising a flexible base plate used during manufacture of an electrode carrier, according to further embodiments of the present invention;

FIG. 8B is a cross-sectional view of the base plate as shown in FIG. 8A, according to embodiments of the present invention;

FIG. 9A is a perspective view of a mold comprising a flexible base plate used during manufacture of an electrode carrier, according to further embodiments of the present invention; and

FIG. 9B is a cross-sectional view of the base plate as shown in FIG. 9A, according to embodiments of the present invention.

### DETAILED DESCRIPTION

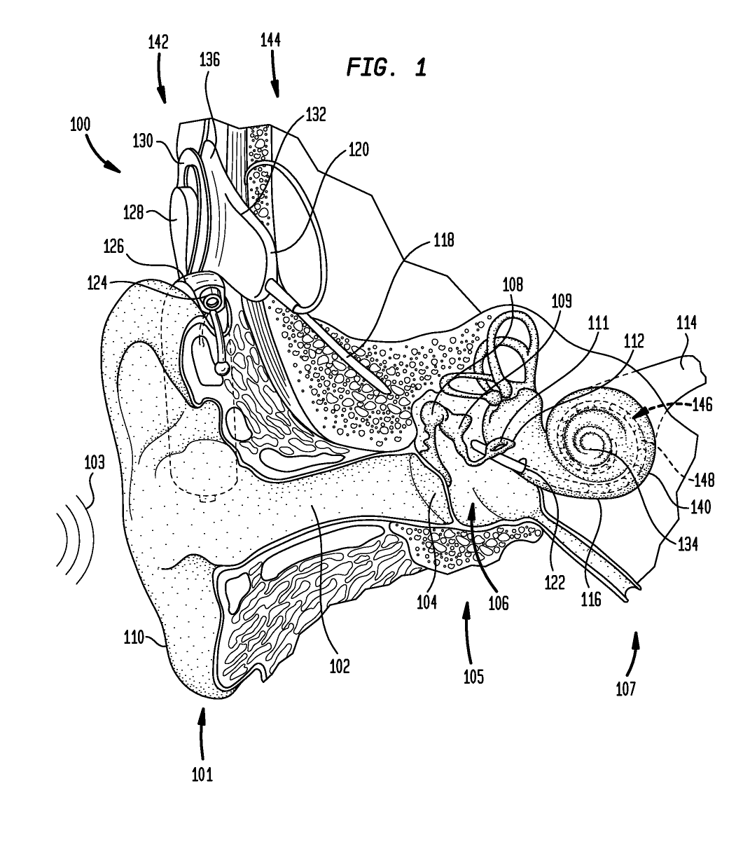

Embodiments of the present invention are generally directed to manufacturing an electrode carrier for an implantable medical device. Embodiments of the present invention are described herein primarily in connection with one type of implantable medical device, a stimulating prosthetic hearing implant. Such prosthetic hearing implants include, but are not limited to, auditory brain stimulators and cochlear implants. FIG. 1 is perspective view of one embodiment of a cochlear implant 100 in which embodiments of the present invention may be implemented. Referring now to FIG. 1, the relevant components of outer ear 101, middle ear 105 and inner ear 107 are described next below. A fully functional ear outer ear 101 comprises an auricle 110 and an ear canal 102. An acoustic pressure or sound wave 103 is collected by auricle 110 and channeled into and through ear canal 102. Disposed across the distal end of ear cannel 102 is a tympanic membrane 104 which vibrates in response to sound wave 103. This vibration is coupled to oval window or fenestra ovalis 112 through three bones of middle ear 105, collectively referred to as the ossicles 106 and comprising the malleus 108, the incus 109 and the stapes 111. Bones 108, 109 and 111 of middle ear 105 serve to filter and amplify sound wave 103, causing oval window 112 to articulate, or vibrate. Such vibration sets up waves of fluid motion within cochlea 140. Such fluid motion, in turn, activates tiny hair cells (not shown) located inside of cochlea 140. Activation of the hair cells causes appropriate nerve impulses to be transferred through the spiral ganglion cells (not shown) and auditory nerve 114 to the brain, where they are perceived as sound.

Cochlear implant 100 comprises external component assembly 142 which is directly or indirectly attached to the body of the recipient, and an internal component assembly 144 which is temporarily or permanently implanted in the recipient. External assembly 142 typically comprises microphone 124 for detecting sound, a speech processing unit 126, a power source (not shown), and an external transmitter unit 128. External transmitter unit 128 comprises an external coil 130 and, preferably, a magnet (not shown) secured directly or indirectly to external coil 130. Speech processing unit 126 processes the output of microphone 124 positioned, in the depicted embodiment, by auricle 110 of the recipient. Speech processing unit 126 generates coded signals, referred to herein as a stimulation data signals, which are provided to external transmitter unit 128 via a cable (not shown).

Internal assembly 144 comprises an internal receiver unit 132, a stimulator unit 120, and an elongate electrode carrier 118. Internal receiver unit 132 comprises an internal transcutaneous transfer coil 136, and preferably, a magnet (also not shown) fixed relative to the internal coil. Internal receiver unit 132 and stimulator unit 120 are hermetically sealed within a biocompatible housing. The internal coil receives power and stimulation data from external coil 130, as noted above. Elongate electrode carrier 118 has a proximal end connected to stimulator unit 120 and extends from stimulator unit 120 to cochlea 140. A distal end of electrode carrier 118 is implanted into cochlea 140 via a cochleostomy 122.

Electrode carrier 118 comprises an electrode array 146 disposed at the distal end thereof. Electrode array 146 comprises a plurality of longitudinally-aligned electrode contacts 148. Stimulation signals generated by stimulator unit 120 are applied by electrode contacts 148 to cochlea 140, thereby stimulating auditory nerve 114.

In one embodiment, external coil 130 transmits electrical signals (i.e., power and stimulation data) to the internal coil via a radio frequency (RF) link. The internal coil is typically a wire antenna coil comprised of multiple turns of electrically insulated single-strand or multi-strand platinum or gold wire. The electrical insulation of the internal coil is provided by a flexible silicone molding (not shown). In use, implantable receiver unit 132 may be positioned in a recess of the temporal bone adjacent auricle 101 of the recipient.

There are several speech coding strategies that may be implemented by speech processor 126 to convert sound 103 into electrical stimulation signals. Embodiments of the present invention may be used in combination with any speech strategy now or later developed, including but not limited to Continuous Interleaved Sampling (CIS), Spectral PEAK Extraction (SPEAK), Advanced Combination Encoders (ACE), Simultaneous Analog Stimulation (SAS), MPS, Paired Pulsatile Sampler (PPS), Quadruple Pulsatile Sampler (QPS), Hybrid Analog Pulsatile (HAPs), n-of-m and HiRes™, developed by Advanced Bionics. SPEAK is a low rate strategy that may operate within the 250-500 Hz range. ACE is a combination of CIS and SPEAK. Examples of such speech strategies are described in U.S. Pat. No. 5,271,397, the entire contents and disclosures of which is hereby incorporated by reference. Embodiments of the present invention may also be used with other speech coding strategies, such as a low rate strategy called Spread of Excitation which is described in U.S. Provisional No. 60/557,675 entitled, “Spread Excitation and MP3 coding Number from Compass UE” filed on Mar. 31, 2004, U.S. Provisional No. 60/616,216 entitled, “Spread of Excitation And Compressed Audible Speech Coding” filed on Oct. 7, 2004, and PCT Application WO 02/17679A1, entitled “Power Efficient Electrical Stimulation,” which are hereby incorporated by reference herein.

Embodiments of cochlear implant 100 may locally store several speech strategies, such as in the form of a software program or otherwise, any one of which may be selected depending, for example, on the aural environment. For example, a recipient may choose one strategy for a low noise environment such as a conversation in an enclosed room, and a different strategy for a high noise environment such as on a public street. The programmed speech strategies may be different versions of the same speech strategy, each programmed with different parameters or settings.

The successful operation of cochlear implant 100 depends in part on its ability to convey pitch information. Differing pitch percepts may be produced by cochlear implant 100 in two distinct ways. First, electrical stimulation at different sites in cochlea 140 excites different groups of neurons. Different pitch sensations are precurved because of the tonotopic arrangement of neurons in cochlea 140. The term “tonotopic” means that the percept corresponding to a particular site in the cochlea changes in pitch from lower to higher as the site is changed in an apical 134 to basal 116 direction. Pitch varied in this way is known as “place pitch.” Also different pulse rates of electrical stimulation produce different pitch sensations. Pitch varied in this way is known as “rate pitch.”

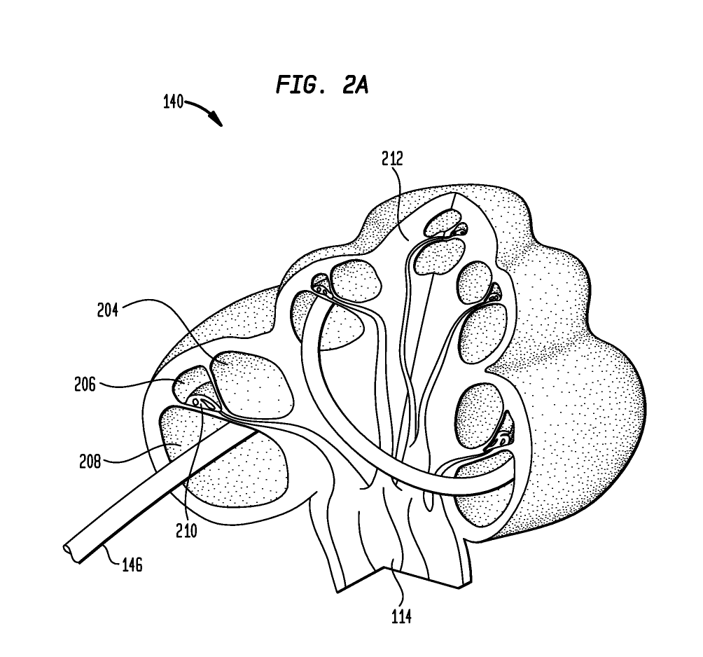

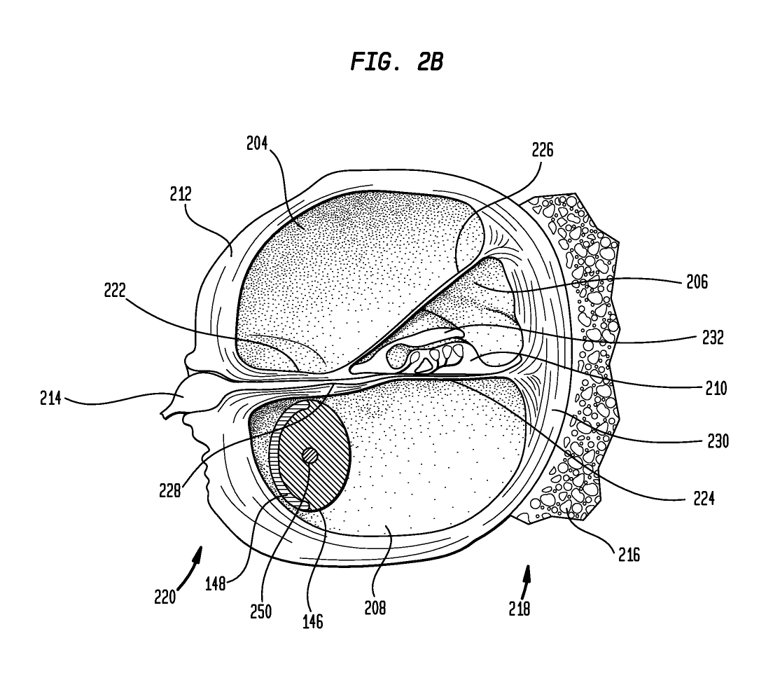

Relevant aspects of a human cochlea are described next below with reference to FIGS. 2A and 2B. FIG. 2A is a perspective view of a human cochlea partially cut-away to display the canals and nerve fibers of the cochlea. FIG. 2B is a cross-sectional view of one turn of the canals of the cochlea illustrated in FIG. 2A. To facilitate understanding, the following description will reference the cochlea illustrated in FIGS. 2A and 2B as cochlea 140, which was introduced above with reference to FIG. 1, and which will be reference below. It should be appreciated that embodiments of the present invention may be implanted in any cochlea to provide therapeutic benefits for a variety of ailments now or later discovered.

Referring to FIG. 2A, cochlea 140 is a conical spiral structure comprising three parallel fluid-filled canals, commonly referred to as ducts. The canals comprise tympanic canal 208, also known as scala tympani 208, vestibular canal 204, also referred to as scala vestibule 204, and median canal 206, also referred to as cochlear duct 206. Cochlea 140 has a conical shaped central axis, the modiolus 212, that forms the inner wall of scala vestibule 204 and scala typani 208. Tympanic and vestibular canals 208, 204 transmit pressure, while medial canal 206 contains the organ of Corti 210 which detects pressure impulses and responds with electrical impulses which travel along the auditory nerve fibers 114 to the brain (not shown). Also shown in FIG. 2A is electrode carrier 146 (FIG. 1) extending in a spiral fashion within scala tympani 208.

Referring now to FIG. 2B, separating the canals of cochlea 140 are various membranes and other tissue. The Ossicous spiral lamina 222 projects from modiolus 212 to separate scala vestibuli 204 from scala tympani 208. Toward lateral side 218 of scala tympani 208, a basilar membrane 224 separates scala tympani 208 from cochlear duct 206. Similarly, toward lateral side 218 of scala vestibuli 204, a vestibular membrane 226, also referred to as the Reissner's membrane 226, separates scala vestibuli 204 from cochlear duct 206.

The fluid in tympanic and vestibular canals 208, 204, referred to as perilymph, has different properties than that of the fluid referred to as endolymph which fills cochlear duct 206 and surrounds organ of Corti 210. Sound entering auricle 110 causes pressure changes in cochlea 140 to travel through the fluid-filled tympanic and vestibular canals 208, 204. As noted, organ of Corti 210 is situated on basilar membrane 224 in cochlear duct 206. It contains rows of 16,000-20,000 hair cells (not shown) which protrude from its surface. Above the hair cells is the tectoral membrane 232 which moves in response to pressure variations in the fluid-filled tympanic and vestibular canals 208, 204. Small relative movements of the layers of membrane 232 cause the hair cells to send a voltage pulse or action potential down the associated nerve fiber 228. Nerve fibers 228, embedded within spiral lamina 222, connect the hair cells with the spiral ganglion cells 214 which form auditory nerve fibers 114 (FIG. 1). These impulses travel to the auditory areas of the brain for processing.

The place along basilar membrane 224 where maximum excitation of the hair cells occurs determines the perception of pitch and loudness according to the above noted place theory. Due to this anatomical arrangement, cochlea 140 has characteristically been referred to as being “tonotopically mapped.” This property of cochlea 140 has traditionally been exploited by longitudinally positioning electrode contacts 148 along carrier 118 to deliver to a selected region within scala tympani 208 a stimulating signal within a predetermined frequency range.

Portions of cochlea 140 are encased in a bony capsule 216. Referring to FIG. 2B, cochlear bony capsule 216 resides on lateral side 218 (the right side as drawn in FIG. 2B), of cochlea 140. Spiral ganglion cells 214 reside on the opposing medial side 220 (the left side as drawn in FIG. 2B) of cochlea 140. A spiral ligament membrane 230 is located between lateral side 218 of spiral tympani 208 and bony capsule 216, and between lateral side 218 of cochlear duct 206 and bony capsule 216. Spiral ligament 230 also typically extends around at least a portion of lateral side 218 of scala vestibuli 204. Also shown in FIG. 2B is a cross-sectional view of an electrode carrier 146 with an electrode 148 and lumen 250 visible. As illustrated, electrode carrier 146 is shown, when in its spiraling position, close to nerve fiber 228 so as to provide stimulating electrical signals directly or indirectly to the nerve fiber.

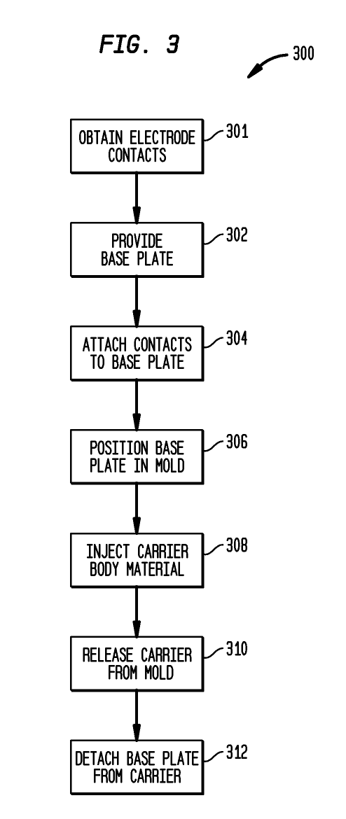

FIG. 3 is a flowchart of one embodiment of the operations performed to manufacture an electrode carrier of the present invention. Process 300 begins at block 301 at which electrode contacts are obtained via any one of various means, including manufacturing contacts, modifying the shape of commercially available contacts, or purchasing commercially available electrode contacts that are ready for use in manufacturing an electrode carrier of the present invention.

After electrode contacts are obtained at block 301, an elongate base plate is provided at block 302 onto which the electrode contacts are attached at block 304. The base plate may be manufactured, purchased or otherwise acquired in the appropriate dimensions. In embodiments of the present invention, the electrode contacts may be attached 304 to the base plate by various means including, but not limited to, adhesives, chemical bonding, welding, mechanical coupling via mechanical coupling features on one or both of the electrode contacts and the base plate.

After the electrode contacts are attached at block 304 to the base plate, the base plate is positioned at block 306 within a pre-formed mold. The mold itself may have one or more features which immobilize the base plate once positioned within the mold. For example, in one embodiment of the present invention, a depression in the mold sized substantially identical to the perimeter of the base plate may be provided in the mold such that the base plate can be placed at least partially into that depression. The depression in the mold may prevent movement of the base plate, including the electrode contacts attached to the base plate, from moving during further handling prior to and during injection of carrier body material into the mold. After the base plate has been positioned within the mold, and after further well-known preparatory activities, the carrier body material is injected into the mold at block 308. It is to be understood that the term “injected” or “inject” as used herein should be understood to encompass placing the carrier body material into the mold through a variety of techniques including, but not limited to, forcing the carrier body material into the mold, allowing the carrier body material to flow, drip or otherwise enter the cavity in the mold through the use of gravitational or centrifugal force, packing the material into the mold, etc. After the carrier body material has cured or otherwise attained a stabilized state in the mold, the cured or stabilized carrier is released from the mold at block 310. Once released from the mold the base plate is detached at block 312 from the electrode contacts and the carrier surrounding the contacts.

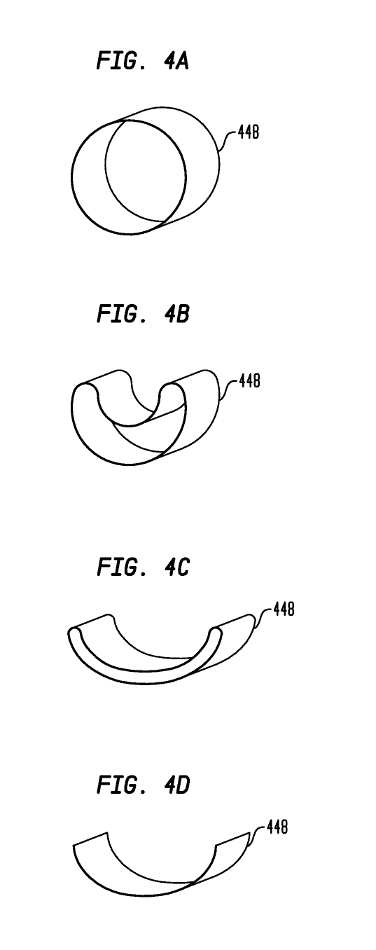

FIGS. 4A-4D are simplified perspective views of an electrode contact 448 according to one embodiment of the present invention. FIG. 4A depicts electrode contact 448 prior to being manipulated or shaped into a form to be used in an electrode carrier according to embodiments of the present invention. In FIG. 4A, electrode contact 448 is shown in cylindrical form, but it is to be understood that electrode contact 448 may be formed from other initial shapes including planar or even irregular shapes. Electrode contact 448 may be made of any conductive or semi-conductive material, as will be appreciated by persons having ordinary skill in the art. Also, although FIGS. 4A-4C show electrode contact 448 being manipulated or otherwise shaped from one shape into a final shape, it is to be understood that in other embodiments of the present invention electrode contact 448 may be formed in a variety of other ways including by stamping, casting, welding, as well as other techniques now known of later developed. In FIG. 4B, electrode contact 448 is illustrated in a transitional state, after being manipulated or shaped by being bent such that one inner wall is pushed towards the opposite inner wall of electrode contact 448. In FIG. 4C, electrode contact 448 is shown in a substantially final state where the material which initially started out in cylindrical form is now folded in half and curved at the ends as shown so as to match the perimeter of the cross-sectional shape of the electrode carrier in which electrode contact 448 is to be incorporated. In embodiments of the present invention which comprise numerous electrode contacts 448 illustrated in FIG. 4A-4C, it is to be understood that electrode contacts 448 may be formed in a manner described above in relation to FIGS. 4A-4C, or in some other manner now known or later developed. In an alternative embodiment, as illustrated in FIG. 4D, an electrode contacts 448 is manufactured from a flat plate which is manipulated into the necessary shape, for example into a curved shape as depicted in FIG. 4D.

It is to be understood that within a single design for an electrode carrier, electrode contacts 448 need not be identical in shape or size. For example, in another embodiment of the present invention the electrode contact gradually tapers distally, to accommodate the gradually decreasing geometry within the cochlea, the electrode contacts gradually decreases in width running distally on the electrode carrier. In other embodiments of the present invention, all electrode contacts are the same width as the width of the most distal (i.e. positioned deepest within the cochlea) electrode contact 448, and therefore the widths of these electrode contacts do not change in width from one contact to another. In still further embodiments of the present invention, the proximal-to-distal lengths of the numerous electrode contacts 448 may be non-uniform for all electrode contacts in the same electrode carrier.

In other embodiments of the present invention, the radial angle between the two endpoints of the electrode contacts, when the electrode contacts are viewed in a cross-sectional view, remain constant among the numerous electrode contacts as the overall side-to-side length varies as the proximal-to-distal cross section varies. In still further embodiments of the present invention where the side-to-side length among the numerous electrodes remains the same as the cross-sectional size decreases toward the distal end, the electrode contacts wrap around the carrier more such that the electrode contacts toward the proximal end wraps around a larger carrier member while the electrode contacts disposed near the distal end wrap around a smaller cross-sectional size and therefore wraps around more of the carrier member. Still further variations in width and length, as used above, as well as other dimensions such as shape, thickness and other aspects are considered a part of the present invention.

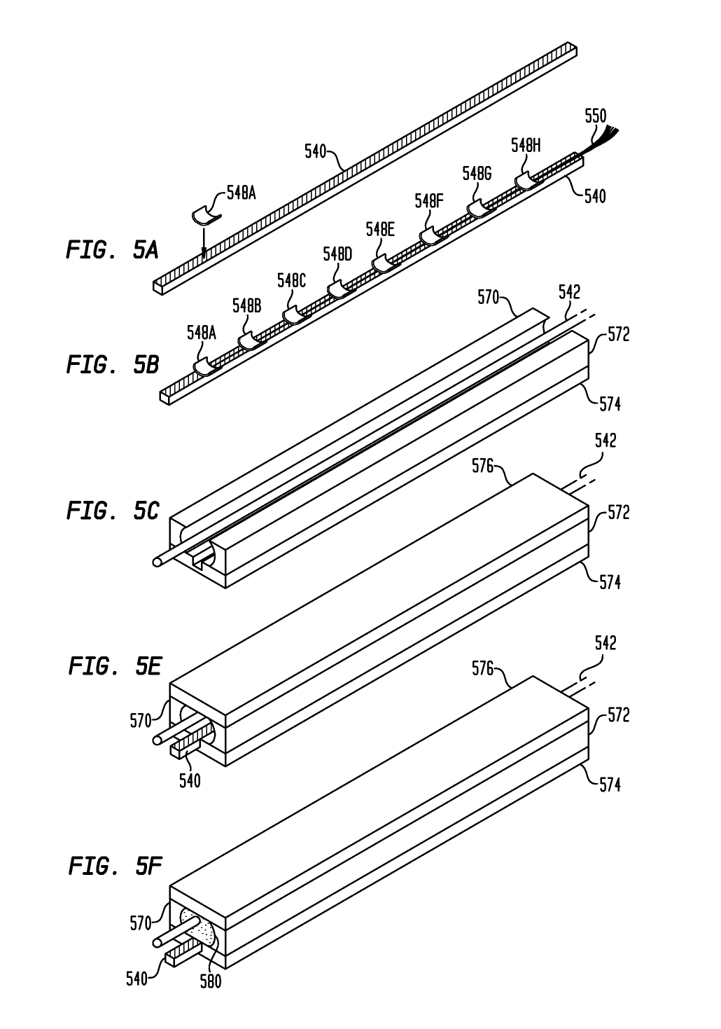

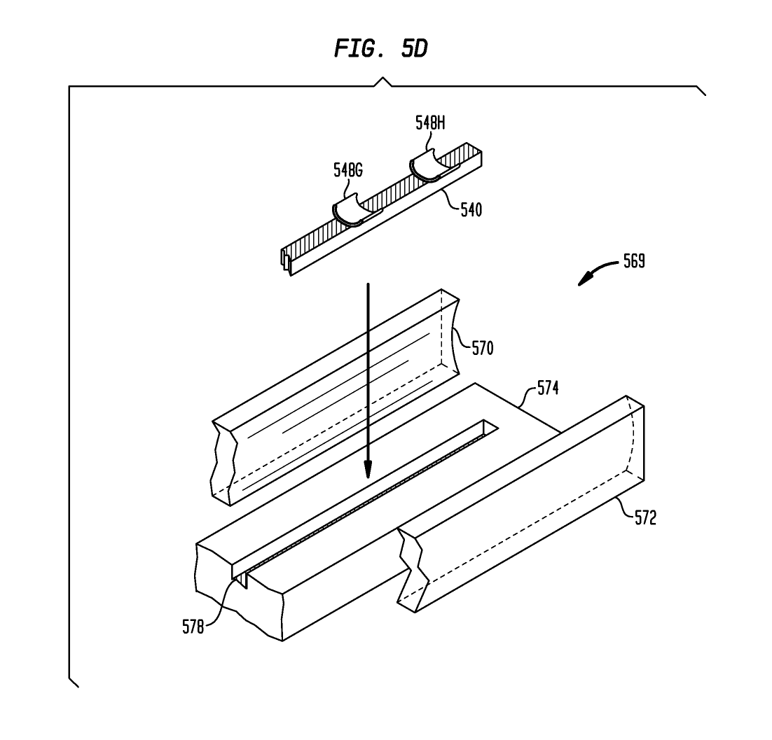

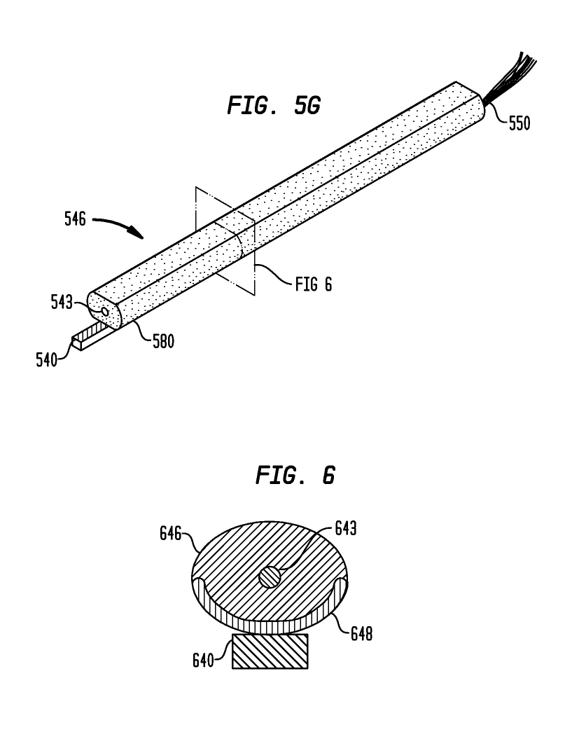

FIG. 5A is a perspective view of a base plate 540 used during manufacturing of an electrode carrier 546 (FIG. 5G) according to one embodiment of the present invention. As illustrated, base plate 540 is a flat elongate plate on which electrode contacts 448, depicted in FIG. 5A as electrode contact 548A, are fixed. FIG. 5B is a perspective view of the base plate of FIG. 5A and multiple electrode contacts 548A-548H (collectively referred to as electrode contacts 548) during manufacturing of electrode carrier 546 according to one embodiment of the present invention. Electrode contacts 548 may be fixed or coupled to base plate 540 through a variety of means. In certain embodiments, electrode contacts 548 may be bonded or welded onto base plate 540. It is to be understood that non-biocompatible materials are not used to form base plate 540 as it is very difficult, if not impossible, to ensure that the base plate 540 and other components such as electrode contacts 548 which are brought into contact with base plate 540 can be made free of all non-biocompatible materials such as irons and etchants, even after a chemical bath or other processes described herein or otherwise associated with separating base plate 540 from electrode contacts 548 after carrier 546 is injected and cured.

In embodiments using bonding to couple electrode contacts 548 to base plate 540, the bond may be broken by heat, solvent or electrodisbonding, as will be appreciated by persons skilled in the relevant art. In one particular embodiment in which a bonding adhesive is used, after the adhesive is prepared, a small quantity of the adhesive is placed on the metal strip at each location where electrode contacts 548 is to be positioned for the injection molding process. One or more electrode contacts 548 are then placed on each of the small quantities of adhesive to secure electrode contacts 548 on base plate 540.

In other embodiments, electrode contacts 548 are mechanically coupled to base plate 540 via cooperating tabs on electrode contacts 548 and base plate 540. In further embodiments, electrode contacts 548 have a protuberance (not shown) which is compression fit into an oppositely but slightly smaller indentation or cutout in base plate 540. Other methods and structures for coupling and subsequently de-coupling electrode contacts 548 and base plate 540 may be employed in other embodiments of the present invention.

In the particular embodiment shown in FIG. 5B, leads 550 are electrically coupled to electrode contacts 548, one lead 550 per electrode contact 548. Each lead in the plurality of leads 550 shown in FIG. 5B are electrically isolated from the rest of the leads as well as those electrode contacts 548 to which the particular lead is not connected. Leads 550 may be electrically coupled to electrode contacts 548 by welding. In certain embodiments of the present invention, electrode contacts 548 may be secured to base plate 540 and then moved to a welding jig (not shown) where leads 550 are welded to their respective electrode contacts 548. After leads 550 are welded to electrode contacts 548, the leads and contacts assembly is moved or otherwise positioned within a molding jig (not shown) in which the molding process described herein occurs. In further embodiments of the present invention, rather than have separate welding and molding jigs, leads 550 may be welded or otherwise secured to electrode contacts 548 on base plate 540 while positioned in a molding jig, followed by injecting the carrier body material while electrode contacts 548 and leads 550 remain in the same molding jig.

FIG. 5C is a perspective view of an injection mold 569 having side walls 570 and 572 and bottom wall 574. Also illustrated is a rod 542 for forming a lumen when material for the electrode carrier 546 is deposited around rod 542. Although not illustrated, lumen-forming rod 542 may be secured in place using a variety of methods. In one embodiment, rod 542 is secured to one of walls 570, 572, 574, or 576. In other embodiments, rod 542 is secured to base plate 540. In yet further embodiments, rod 542 is secured to an external structure, against which walls 570, 572, 574 or 576 are also secured.

As persons having ordinary skill in the art will appreciate, in one embodiment, walls 570, 572, 574 and 576 are designed and manufactured to collectively form a confined space 580 to minimize or preferably prevent leakage when materials are injected, sometimes under pressure and/or heat. As persons having ordinary skill in the art will also appreciate, space 580 may be defined using a different number of walls or space-forming structures than shown in FIGS. 5A-5F. For example, in one embodiment, mold 569 may instead be unitary. In other embodiments, mold 569 may be an integrated assembly of walls 570, 572 and 574.

As illustrated in FIG. 5D, base plate 540 having electrode contacts 548G and 548H (in addition to other electrode contacts 548 not shown) is illustrated prior to being placed in a groove 578 which has been specifically dimensioned to receive base plate 540, and to snugly hold it in place during injection molding and handling. Specifically, the side walls of groove 578 may be made precisely to receive base plate 540, relying on gravity or other securing means (not shown) to hold base plate 540 in place within groove 578.

FIG. 5E is a more detailed view of base plate 540 and lumen-forming rod 542 positioned within space 580 formed by mold walls 570, 572, 574 and top wall 576. Although the term “injection molded” is used herein, it is to be understood that other materials suitable for forming an electrode carrier 546 may be utilized in embodiments of the present invention. FIG. 5F shows electrode carrier 546 after material has been injected into space 580. The material to be injected may be chosen from a variety of materials, or combinations thereof. In embodiments of the present invention, such material may include, but is not limited to, silicone polymers.

FIG. 5G is a perspective view of electrode carrier 546 after curing or otherwise at least partially stabilizing, according to one embodiment of the present invention. It is to be understood that electrode carrier 546 as depicted in FIG. 5G is not in a final state for use, but is instead illustrated after being removed from mold 569. As illustrated, a lumen 543 has been formed upon removal of lumen-forming rod 542 (not shown). Base plate 540 is still attached to electrode carrier 546 in the embodiment depicted in FIG. 5G. Although the particular embodiment of the present invention depicted in FIG. 5G depicts an electrode carrier 546 having a lumen with open-ends, it is to be understood that forming an electrode carrier having no lumen, or having a lumen with a single open-end may be implemented in alternative embodiments of the present invention.

FIG. 6 is a simplified cross-sectional view of an electrode carrier 546 manufactured according to one embodiment of the present invention. As shown, carrier member 680 comprised of the cured material has a longitudinal lumen 643 therein. One of multiple electrode contacts 648 is illustrated in FIG. 6, along with base plate 640.

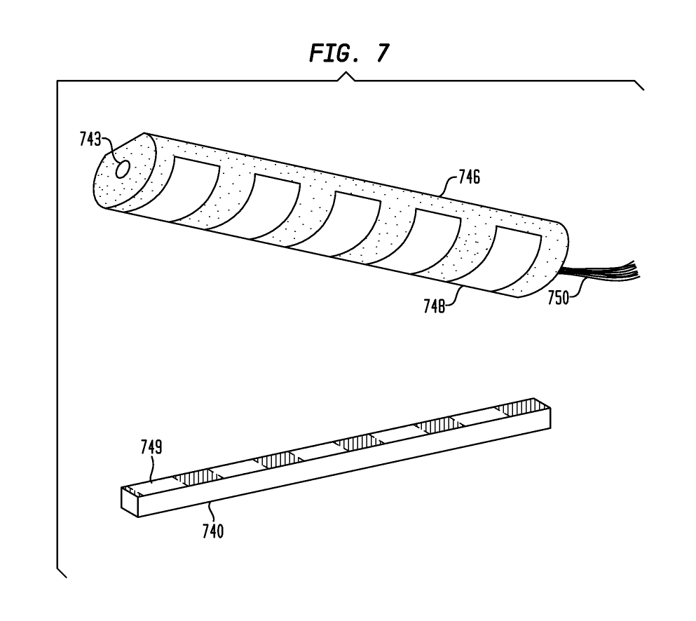

FIG. 7 is a perspective view of an electrode carrier manufactured according to one embodiment of the present invention in which a base plate is shown after being separated from the electrode carrier. As shown, a plurality of electrode contacts 748 is separated from base plate 740. The contact points 749 on base plate 740 where electrode contacts 748 were formerly attached is also shown. As described above, electrode contacts 748 may be detached or decoupled from base plate 740 in a various ways, depending on how electrode contacts 748 were coupled to base plate 740. In one embodiment of the present invention, where electrode contacts 648 were welded to base plate 740, base plate 740 may be physically broken off from electrode contacts 748 at contact points 749. In order to break electrode contacts 748 and base plate 740 from one another, sharp tweezers or other tools may be used to pry or cut electrode contacts 748 from base plate 740. In other embodiments of the present invention, a laser knife or other cutting implement may be used to detach electrode contacts 748 and base plate 740. In further embodiments a chemical etch may be used to etch away base plate 740 from electrode contacts 748. In such embodiments in which base plate 740 is chemically etched away from electrode contacts 748, electrode contacts 748 are washed to remove residue and chemicals for biocompatibility purposes.

Alternatively, in embodiments of the present invention in which electrodisbonding adhesive is used to secure electrode contacts 748 onto base plate 740, electrical current may be used to remove electrode contacts 748 from base plate 740 by applying a current between base plate 740 and electrode contacts 748. In one embodiment of the present invention, a power supply (not shown) is electrically coupled to base plate 740 which acts as a cathode. Electrical current is passed through electrode contacts 748 which act as anodes to detach electrode contacts 748 from base plate 740. While current is being applied to base plate 740 and electrode contacts 748, base plate 740 and electrode contacts 748 are slowly pulled apart from one another. After electrodisbonding is finished, electrode contacts 748 are washed to remove any adhesive or other reside from electrode contacts 748.

In other embodiments of the present invention where adhesive is used to attach or mount electrode contacts 748 to base plate 740 at contact points 749, an appropriately selected solvent may be used to decouple electrode contacts 748 from base plate 740.

After electrode carrier 780 has been removed from the base plate 740, carrier 780 is washed to remove any residue from array 546. For example, in one embodiment of the present invention, excess or unwanted welding particles may be removed by the washing step. In other embodiments of the present invention, adhesives may be removed during the washing step.

It is to be understood that the various embodiments described herein and illustrated in the figures are simplified for clarification purposes. Furthermore, it is to be understood that other embodiments are also considered a part of the present invention. For example, although the various embodiments described herein refer to figures in which the electrode carriers and the molds used to manufacture the various embodiments of the electrode carrier are substantially straight. However, in other embodiments of the present invention, the electrode carrier is manufactured so as to have a natural curved shape, in which the radius of the curve of the carrier member is substantially equal to the curvature radius found in a target cochlea. In further embodiments, the radius of the curve of the carrier member may be different, for example generally less than or greater than, the curvature found in a target cochlea. In yet other embodiments, the carrier member may be manufactured according to the present invention to have differ radii between different regions or portions of the carrier member, so as to facilitate insertion, to more closely resemble different radii found in a target cochlea, and/or to accommodate various anatomical features found in or around a target cochlea.

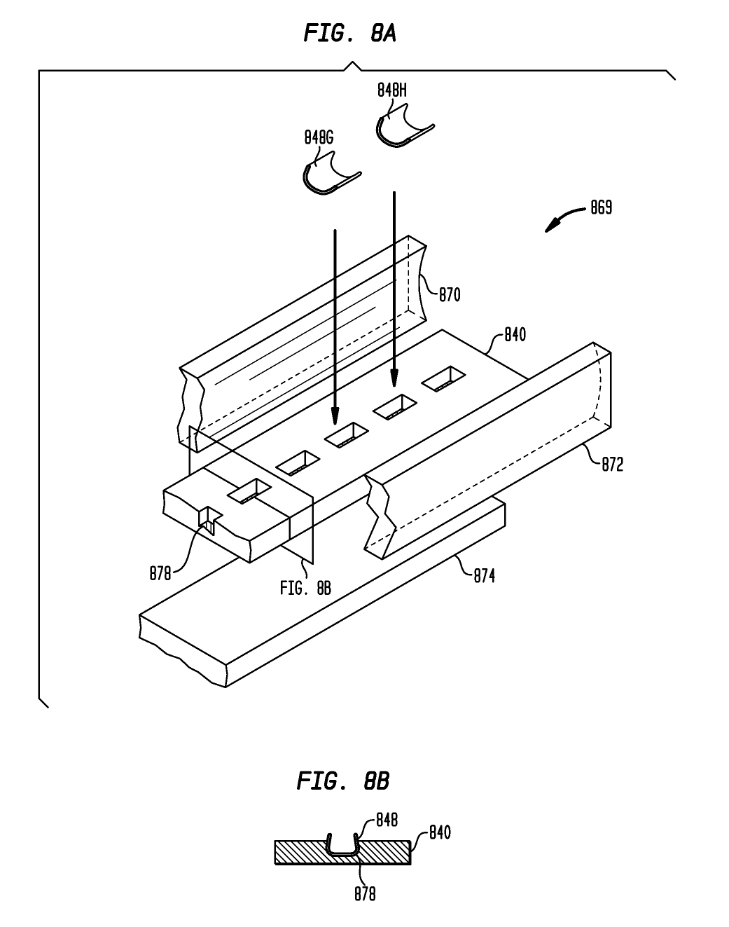

In alternative embodiments of the present invention, a carrier member is manufactured in a mold wherein the electrodes of the carrier member are secured at least partially within a flexible base plate. In an exemplary embodiment, as illustrated in FIGS. 8A and 8B, a flexible base plate 840 is provided in a “ladder” configuration where cutouts or recesses 878 along the flexible base plate 840 are configured to receive (shown as downward arrows) electrode contacts 848 (shown in FIG. 8A as electrode contacts 848G and 848H) positioned within recesses 878. Although FIGS. 8A and 8B depicts recesses 878, it is to be understood that in other embodiments of the present invention, cutouts 878 will be accessible from both the top as well as bottom faces of base plate 840. In certain embodiments of the present invention, leads (not shown) described above will be welded or otherwise secured to electrode contacts 848 from through the cutout 878 from the bottom face of base plate 840. In other embodiments of the present invention, leads (not shown) will be welded or secured to electrode contacts 848 from the top face of base plate 840.

In other embodiments of the present invention, where base plate 840 is made with a silicone material, base plate 840 and cutouts 878 are a part of the finished carrier member. In such embodiments, after electrode contacts 848 are positioned within cutouts 878 and various leads and other components are secured to electrode contacts 848, the base plate 840 and other components secured therein are positioned in a mold and carrier body material is injected into the mold. However, in these embodiments, rather than separating electrode contacts 848 from base plate 840, base plate 840 remain a part of the finished carrier member. In such embodiments, the surface of electrode contacts 848 exposed at the bottom face of base plate 840 is used to transfer or receive signals to the target tissue after the carrier member is implanted in the recipient.

FIG. 8B is a cross-sectional view of base plate 840. In the cross-sectional view, an electrode contact 848 is shown already positioned within recess 878 of flexible base plate 840. After electrode contacts 848 are positioned within recesses 878 of flexible base plate 840, flexible base plate 840 is moved or otherwise positioned within the mold 869. Carrier body material is then injected as described above. After curing, the carrier member is removed from mold 869. Although sides mold walls 870, 872 and bottom wall 874 are shown, it is to be understood that the mold used may have fewer or more walls or an entirely different configuration than that illustrated and is considered a part of the present invention. In other embodiments of the present invention (not shown), flexible base plate 840 may also act as the bottom wall 874 of the mold.

In particular embodiments of the invention illustrated in FIG. 8A, the carrier body material may be provided in two parts or stages. The first stage will involve providing the curable injection material onto flexible base plate 840 so that the injection material surrounds electrode contacts 848. After curing the injected material, the partially formed carrier member with electrode contacts 848 disposed partially therein is separated from base plate 840. After this separation, in a second stage, more injection material is provided on the partially formed carrier such that injection material will fill in the space between the electrode contacts 848 which now protrude away from the carrier member. This second stage may be performed after placing the partially formed carrier into a second mold (not shown) configured without “ladder” configuration cutouts or recesses. Rather, the second mold (not shown) may have a cavity or chamber which, when injected with carrier body material, will produce a carrier which encompasses the rest of the carrier member such that the not covered during the first stage will be substantially surrounded, in addition to the space between the electrode contacts 848.

By using a flexible base plate 840 in these embodiments, there is no need to attach the electrode contacts 848 onto the surface of base plate 840 as described above with respect to other embodiments of the present invention, for example by welding or bonding. By not having to weld or bond or otherwise attach the electrode contacts to the mold or base plate, the separation and other preparation steps are made simpler and freer of contaminants and other materials which could otherwise be present from the welding or bonding according to this alternative embodiment of the present invention.

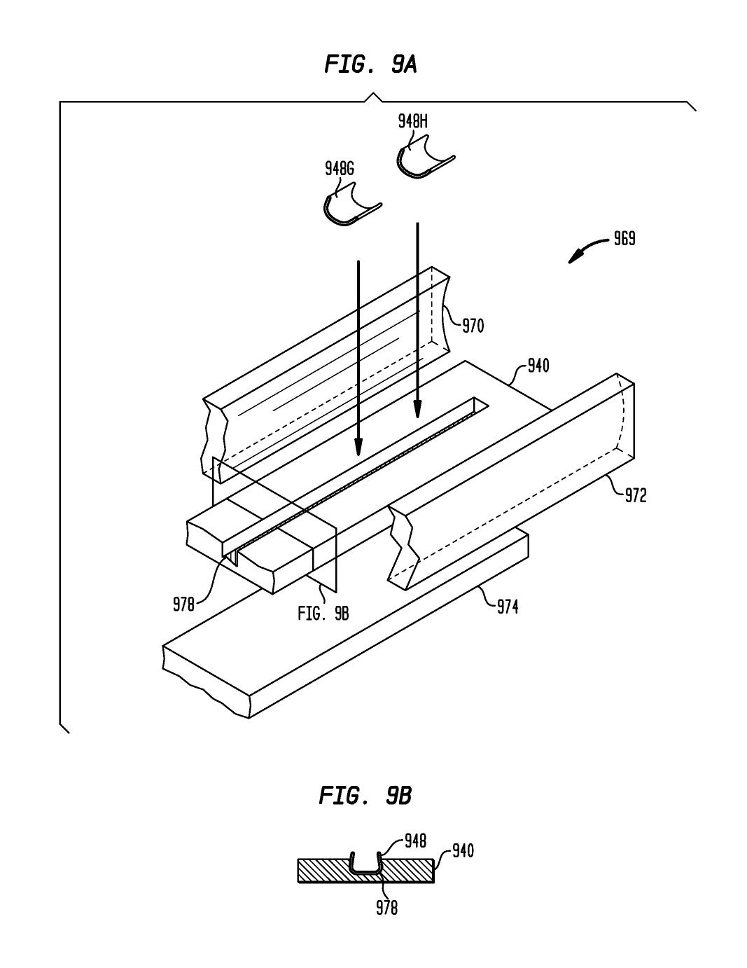

In yet other alternative embodiments of the present invention, as illustrated in FIGS. 9A and 9B, flexible base plate 940 is provided with a longitudinal channel 978 into which electrode contacts 948 are positioned. After electrode contacts 948 are positioned along longitudinal channel 978, carrier body material is injected into channel 978 so as to surround the inserted electrode contacts 948 as well as the space in the mold between electrode contacts 948 such that a unitary carrier is produced in or on which electrode contacts 948 are securely disposed. Although sides mold walls 970, 972 and bottom wall 974 are shown, it is to be understood that the mold used may have fewer or more walls or an entirely different configuration than that illustrated and is considered a part of the present invention. For example in certain alternative embodiments, flexible base plate 940 may also act as a bottom wall 974 so that a separate bottom wall 974 is not present. After curing the body material, the carrier electrode contacts 948 undergoes any finishing steps of the manufacturing process as described above.

Base plate 840 as well as 940 may comprise various materials which will allow it the flexibility to both receive electrode contacts 848, 948 and to retain contacts 848, 948 upon their being positioned within recesses 878 or channel 978. Polymers such as PTFE, silicone, polyurethane, PEEK are suitable materials with which to construct base plate 840, 940.

It is to be understood that although embodiments of the present invention have been described above as “elongate carriers”, other embodiments of the present invention which are not necessarily long and narrow are contemplated and are considered a part of the present invention. While an elongate carrier having one or more electrode contacts may be suitable for certain uses, for example insertion into and stimulation within a recipient's cochlea, other uses such as stimulating various other organs in a recipient may permit or even require other geometries and configurations such as a substantially circular electrode carrier, a cylindrical electrode carrier, and others. It is to be understood that various configurations of electrode carriers may be manufactured according to the present invention.

Furthermore, while embodiments of the present invention described above have been described as comprising multiple electrode contacts, it is to be understood that in other embodiments of the present invention, the electrode carrier may comprise only a single electrode contact. As used herein, “electrical contact”, “electrode contact” and “electrode” have been used interchangeably.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A method for manufacturing an implantable assembly of a medical device, the assembly comprising a carrier with one or more electrode contacts disposed there in, comprising:
coupling at least one electrode to a base plate;
securing the base plate in a mold;
injecting the mold with injection material at least partially around said at least one electrode;
curing the injected material; and
decoupling said at least one electrode from the base plate such that said cured injection material is separated from said base plate.

2. The method of claim 1, further comprising:
deforming said at least one electrode from a first shape to a second shape, wherein said coupled at least one electrode is a deformed electrode.

3. The method of claim 2, wherein said second shape is a “u” shape.

4. The method of claim 1, further comprising:
electrically coupling a conductive wire to each of said at least one electrode prior to said injecting the mold with injection material.

5. The method of claim 4, further comprising:
depositing silicone on said conductive wire where said electrode and said conductive wire are electrically coupled.

6. The method of claim 1, further comprising:
positioning an elongate rod in said mold prior to said injecting the mold with injection material such that a lumen longitudinally extending in said electrode carrier is formed upon said injecting the mold.

7. The method of claim 1, wherein said base plate comprises platinum.

8. The method of claim 1, wherein coupling at least one electrode to a base plate comprises welding at least one electrode to a base plate.

9. The method of claim 8, wherein said welding comprises resistance welding.

10. The method of claim 9, further comprising washing said assembly after said decoupling said at least one electrode from the base plate.

11. The method of claim 8, wherein said decoupling of said at least one electrode from the base plate is by cutting said at least one welded electrode from said base plate.

12. The method of claim 1, wherein coupling at least one electrode to a base plate comprises bonding at least one electrode to a base plate.

13. The method of claim 12, wherein said decoupling at least one electrode from the base plate comprises disbonding said at least one bonded electrode from said base plate.

14. The method of claim 12, wherein bonding at least one electrode to a base plate comprises applying an electrodisbonding adhesive between at least one electrode and a base plate.

15. The method of claim 14, wherein said decoupling of said at least one electrode from the base plate comprises applying a current to said conductive wire to disband said at least one electrode from said base plate.

16. The method of claim 15, further comprising:
coupling the base plate to a power source, and wherein said decoupling said at least one electrode from the base plate further comprises conducting an electrical current through said base plate and said at least one electrode.

17. The method of claim 16, further comprising washing said assembly after said decoupling said at least one electrode from the base plate.

18. The method of claim 1, wherein said decoupling at least one electrode from the base plate comprises etching away said base plate from said at least one electrode.

19. The method of claim 18, wherein said etching away said at least one electrode from the base plate comprises exposing said base plate to a chemical etchant.

20. The method of claim 18, wherein said etching comprises laser etching.

21. The method of claim 1, wherein said injection material comprises curable silicone polymer.

22. The method of claim 1, further comprising:
washing said decoupled electrode carrier.

23. The method of claim 1, wherein said mold is a curved mold such that said electrode carrier manufactured in said curved mold is curved.

24. The method of claim 23, further comprising curving said base plate following said coupling at least one electrode to the base plate.

25. The method of claim 1, further comprising curing said injected injection material.

26. The method of claim 1, wherein said coupling at least one electrode to the base plate further comprises inserting the at least one electrode into a longitudinal channel disposed longitudinally along the base plate and configured to retain the at least one electrode during said injecting the mold with injection material.

27. The method of claim 1, wherein said coupling at least one electrode to the base plate further comprises inserting the at least one electrode into one of a plurality of recesses disposed longitudinally along the base plate and configured to retain the at least one electrode during said injecting the mold with injection material.

28. A system for manufacturing an implantable assembly of a medical device, the assembly comprising a carrier with one or more electrode contacts disposed there in, comprising:
means for coupling the one or more electrode contacts to a base plate;
means for securing the base plate in a mold;
means for injecting the mold with injection material at least partially around the one or more electrode contacts;
means for curing the injected material; and
means for decoupling the one or more electrode contacts from the base plate such that said cured injection material is separated from said base plate.

29. The system of claim 28, further comprising:
means for depositing of silicone on said conductive wire where the one or more electrode contacts and said conductive wire are electrically coupled.

30. The system of claim 28, wherein said means for coupling the one or more electrode contacts to a base plate comprises means for welding the one or more electrode contacts to a base plate.

31. The system of claim 30, wherein said means for decoupling of said the one or more electrode contacts from the base plate comprises means for cutting said the one or more welded electrode contacts from said base plate.

32. The system of claim 28, wherein said means for coupling the one or more electrode contacts to a base plate comprises means for bonding the one or more electrode contacts to a base plate.

33. The system of claim 32, wherein said means for bonding the one or more electrode contacts to a base plate comprises means for applying an electrodisbonding adhesive between the one or more electrode contacts and a base plate.
